(19) United States
(12) Patent Application Publication
(10) Pub. No.: US 2020/0262548 A1
(43) Pub. Date: Aug. 20, 2020

(54) LOW-VIBRATION DRONE

(71) Applicant: EVODRONE, Issoire (FR)

(72) Inventors: Arthur GARDIN, Issoire (FR); Florent ROQUE, Issoire (FR)

(21) Appl. No.: 16/062,794

(22) PCT Filed: Dec. 15, 2016
(86) PCT No.: PCT/IB2016/057651

§ 371 Date: Jun. 15, 2018

(30) Foreign Application Priority Data
Dec. 17, 2015 (FR) 15/02625

(51) Int. Cl. B64C 27/00

(52) U.S. Cl. CPC B64C 27/001; B64C 39/024; B64C 2027/002

(57) ABSTRACT

A drone includes a fuselage and a plurality of housing structures for a plurality of engine units. The mechanical connection between each engine unit and each housing structure for the engine unit has: a ball joint arranged in the axis of rotation of the engine unit, opposite the rotor; and a flexible connecting member connecting the engine unit to the housing structure for the engine unit.

### CROSS-REFERENCE TO RELATED APPLICATIONS

This is a National Stage Entry into the United States Patent and Trademark Office from International PCT Patent Application No. PCT/IB2016/057651, having an international filing date of Dec. 15, 2016, which claims priority to French Patent Application No. FR 15/02625, filed on Dec. 17, 2015, the entire contents of both of which are incorporated herein by reference.

### FIELD OF THE INVENTION

The present invention relates to a multirotor drone. It relates more particularly to a drone comprising a fuselage and a plurality of housing structures for a plurality of powertrains.

### DESCRIPTION OF RELATED ART

With the permanent miniaturization of electronics, a new type of drone has emerged over the past short decade in the category of mini-drones (“MTOW”<25 kg): multirotor drones. These rotary wing aircraft consist of several rotors (at least 3) whose different thrusts allow lift and control of the drone. The major advantage of this configuration, compared to conventional helicopters, lies in its simplicity: just a few motors directly driving rotors, controlled by an inertial unit and controlled by a small computer, are sufficient for flying almost any object.

First used as recreational vehicles, these multirotor drones have seen their areas of use diversify considerably: they are now used professionally to accomplish very diverse missions. These missions can take the form of objects to be transported/raised in the air, or of information gathering in all their forms by means of sensors embedded in the aircraft (aerial shooting, mapping, surveys of all kinds, etc.).

These professional applications require both exemplary reliability and optimal accuracy of the information capture. Vibrations are particularly harmful for the reliability and precision of drones. Indeed, the inertial units, which determine the position of the drone in space, are very sensitive to vibrations. These can cause drifts and disorient the drone which then becomes uncontrollable. The vibrations can also be responsible for disengagement in flight of the drone, due to the loss of fastening screws or premature structural fatigue for example. On the other hand, the vibrations transmitted to the on-board sensors for the mission (cameras, photo cameras, infrared sensors, etc.) can drastically reduce the accuracy of measurements. We will mention in particular the phenomenon of “rolling shutter” well known to photographers, and directly related to the vibrations of a camera, which is responsible for obvious geometric aberrations.

Reducing the level of vibration is therefore an essential problem for the design of a professional drone. The strategy currently implemented by the majority of drone manufacturers consists in isolating only the sensor (camera or other) from the structure of the drone via silentblocs (isolator bushings). Although functional, this strategy has two major drawbacks: the vibrations are transmitted to the inertial unit, thus disturbing the reading of the accelerometers and gyroscopes that condition the stability of the flight and the structure of the drone remains subjected to vibrations, which can lead to serious reliability problems (disruption of the inertial unit, loss of screws during flight, premature structural fatigue, etc.).

Some manufacturers also mount the engines on silentblocs. This technique has only a very limited effectiveness since it requires the use of very rigid silentblocs in order to limit dynamic coupling phenomena. Indeed, the use of simple silentblocs does not allow for the natural modes of vibration of the engine on its support to be known precisely. Therefore, it is essential to have a sufficiently rigid mounting so that the natural frequencies of the assembly are away from the rotational speeds of the engine, at the risk of causing destructive resonances, which would be the opposite effect to that sought. Therefore, only very high frequencies, rarely problematic on drones, can be isolated.

Other drone manufacturers install the inertial unit on an insulating material. Here again, the effectiveness of this solution is very limited because of the very small mass of an inertial unit, and therefore the difficulty of isolating it from relatively low frequencies (of the order of the rotational speed of the motors). In theory, to obtain an effective assembly, it would either be necessary to weigh down the inertial unit, unthinkable in a drone whose lightness is paramount, or use insulating materials with extremely low rigidity. In the latter case, the inertial unit is almost no longer integral with the drone and the mere presence of electrical cables connected to the central unit can be enough to change the orientation, and thus to distort the measurements and disorient the drone.

We therefore note that the vibratory problem is only partially solved in the current multirotors. A solution to this problem is to effectively isolate the vibrations at the source, i.e. directly at the powertrain. However, unlike vibratory isolation of a sensor or an inertial unit, isolating a powertrain requires that certain forces be transmitted rigidly: the traction required for the flight of the drone, and the torque required for control of the drone in yaw. The use of simple silentblocs does not allow this constraint to be complied with.

European Patent No. EP 2599718 discloses a disk-shaped drone comprising a body housing a plurality of rotors oriented horizontally and driven by motors. Each of the rotors is in connection with the body via a support arm. The body serves as anchor for the rotor support arms. The body is arranged centrally in the platform housing.

To overcome these disadvantages, the invention provides various technical means.

### SUMMARY OF THE INVENTION

The object of the invention consists in providing a device for isolating in a particularly effective manner the vibrations from a multirotor drone powertrain, while transmitting the necessary efforts to control the drone.

To do this, the invention provides a drone comprising a fuselage and a plurality of housing structures in which are arranged a plurality of powertrains, a mechanical connection between each powertrain and each powertrain housing structure, wherein said mechanical connection between each powertrain and each powertrain housing structure comprises a flexible connecting member connecting the powertrain to the powertrain housing structure, said mechanical connection between each powertrain and each powertrain housing structure further comprising a universal joint arranged in the axis of rotation of the powertrain, opposite the rotor.

According to such an architecture, an excellent decoupling between the powertrain and the structure of the drone is obtained, thus allowing a reduction of the vibrations.

According to an advantageous embodiment, the flexible connecting member is remote from said universal joint.

The universal joint is advantageously anti-torque.

Advantageously, the flexible connecting member is an elastomeric membrane fixed on the one hand to the upper portion of the powertrain, and on the other hand to the housing structure.

According to such an architecture, the universal joint has the advantage of being inexpensive, durable and effective.

Advantageously, the universal joint comprises a spiral membrane cooperating on the one hand with the housing structure and on the other hand with the powertrain and a multiaxial flexible connection in which a prominent portion of the powertrain is inserted.

Advantageously, the damping ratio R=I/L is between 0.01 and 1, preferably between 0.4 and 1 and more preferably between 0.6 and 0.9, where L is the distance between the universal joint and the plane of the rotor, and I corresponds to the distance between said joint and the attachment point of the flexible connection with the powertrain.

### BRIEF DESCRIPTION OF THE DRAWINGS

All the embodiment details are given in the description which follows, supplemented by FIGS. 1 to 5B, presented solely for purposes of non-limiting examples, and in which:

FIG. 1A is a schematic view illustrating the main efforts to be taken into account in a multirotor drone architecture;

FIG. 1B is a sectional view in the vertical plane of the powertrain housing and of the powertrain, with a symbolic representation of the damping system according to the invention;

FIG. 1C is a perspective view of an example of a drone provided with a plurality of powertrain housing structures arranged at the end of arms carried by the fuselage of the drone;

FIG. 2 is a sectional view in the vertical plane of an example of housing structure of the powertrain and an example of implementation of a damping system;

FIG. 3 is a top view of the housing structure of the powertrain enabling the extreme positrons allowed by the damping system according to the invention to be seen;

FIGS. 4A and 4B illustrate an example of a joint or ball joint according to the invention; and

FIGS. 5A and 5B illustrate two examples of flexible fastening according to the invention.

### DETAILED DESCRIPTION OF THE INVENTION

“Drone” 1 means a remotely piloted aircraft as defined in the decree of 11 Apr. 2012 on the “design of civil aircraft that operate without any person on board, the conditions of their use and the capabilities required of the persons who use them”. In short, it refers to any aircraft capable of unmanned flight, which is controlled either by a computer (on board or on the ground) or by an operator on the ground, used for recreational, competition, or professional purposes.

“Rotary wing” means any drone whose lift in the air is obtained by means of at least one rotor 6, allowing the drone to hover. The invention relates preferentially to multirotor drones equipped with three to eight rotors.

“Powertrain 4” means a powertrain comprising a motor, a rotor with fixed pitch or variable pitch, and all the transmission elements between the motor and the rotor 6 (gearbox, rotor head, axis of rotation 5, blade holders, etc.).

“MTOW” means “maximum take off weight”, which is the maximum take-off weight of an aircraft, i.e. the mass beyond which an aircraft cannot take off without potentially harming the safety of the aircraft. flight.

“Rolling Shutter” means the image acquisition technique on a digital sensor, which consists of recording line by line the image received by the sensor. This technique causes geometric aberrations, or image distortions, during the acquisition of moving objects or when the sensor is subjected to vibrations.

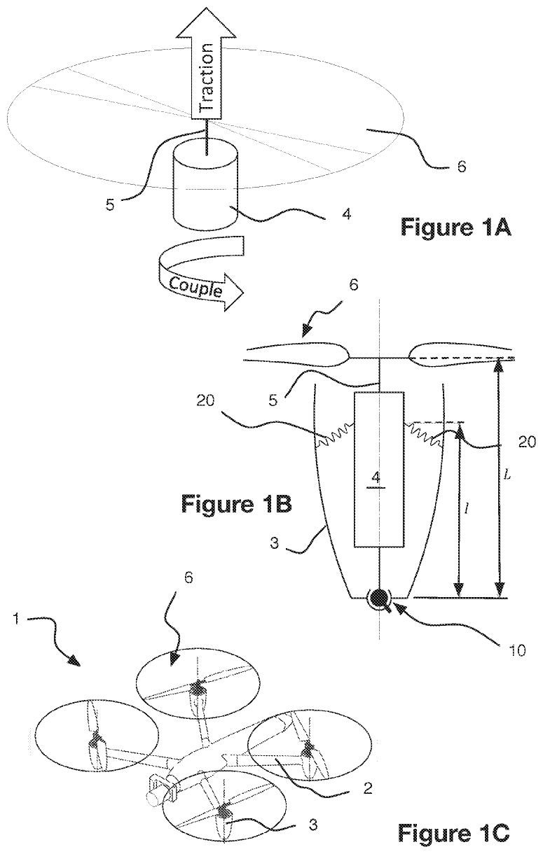

FIG. 1A illustrates the key efforts involved in a rotor arrangement. The latter must be able to transmit the traction force. The torque transmitted by the motor must be supported by the fastening means. The fastening assembly, in addition to being adapted to the latter constraints, must be able to dampen the vibrations as well as possible. As these various technical requirements are often contradictory, it is relatively complex to reach a right balance between these various constraints, which explains why drones known to date still do not comprise an optimal solution.

FIG. 1C illustrates an example of a multirotor drone 1 comprising a plurality of housing structures 3 such as that illustrated in the example of FIG. 1B.

The objective sought by vibratory isolation is to modify the stiffness of the connection between the exciting element and its support in the direction of excitation, so that the cutoff frequency of this connection is much lower than the frequency of excitation.

The exciting element is the powertrain 4, and more precisely the rotor 6 where most of the vibrations originate (imbalance, geometric defect, etc.). The direction of the excitation is the plane materialized by the rotor disk 6. The support of the exciting element is the structure of the drone. The connection between the exciting element and its support is the attachment of the powertrain 4 in the housing structure 3 of the powertrain.

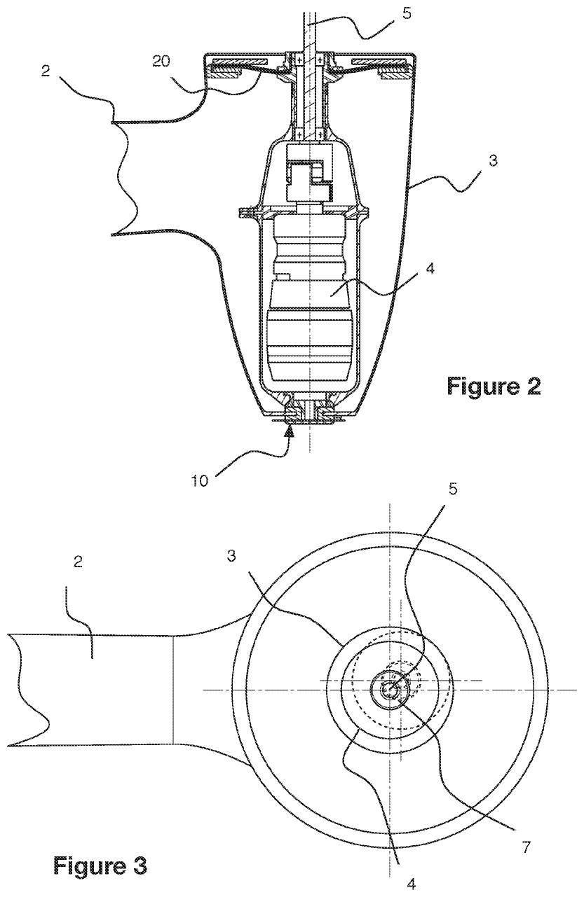

The objective is therefore to modify the stiffness with which the powertrain 4 is held in the plane of the rotor 6, while transmitting the torque and the traction provided by the powertrain as shown in the diagram of FIG. 1A. For this, the invention proposes a mounting, as shown diagrammatically in FIG. 2, composed of a connection of the universal joint 10 or finger ball joint type, arranged at a reasonable distance from the rotor 6, and connecting the powertrain 4 to the structure of the drone 1, as well as flexible connecting members 20, arranged between the universal joint 10 and the rotor 6, also connecting the powertrain 4 to the housing structure 3 and whose mechanical characteristics (stiffness and damping) are adapted to the frequencies to be isolated.

As shown in FIG. 1 B and FIG. 2, this architecture makes it possible to transmit the traction and torque forces of the powertrain to the structure via the universal joint, while isolating the motions of the powertrain 4 in the plane of the rotor 6 thanks to the flexible connecting members 20.

FIG. 3 illustrates the beneficial effect of this configuration, with a view from above of a powertrain 4 arranged in a housing structure 3. The solid lines represent the initial position of the ball bearing 7 of the rotor axis. The dashed lines represent the powertrain 4 in maximum deflection position.

### Characteristic Length L

As shown in FIG. 1B, the characteristic length is defined as the distance L between the universal joint 10 and the plane of the rotor. To maximize the efficiency of the invention, this characteristic length must be related to the diameter D of the rotor 6, and a characteristic length is preferably chosen in the following ranges: an extended characteristic length range for which the distance L is greater than or equal to 0.5.D and less than or equal to 2.D. A first preferred characteristic length range for which the distance L is greater than or equal to 0.2.D and less than or equal to 1.5.D. Finally, a second preferred characteristic length range for which the distance L is greater than or equal to 0.5.D and less than or equal to 1.D.

### Damping Ratio

The damping ratio is defined by R=I/L where L is the distance between the universal joint 10 and the plane of the rotor 6 and I is the distance between the joint 10 and the point of attachment of the flexible connecting members 20 to the powertrain 4. For maximum efficiency of the invention, R is selected in the following ranges: an extended damping ratio range in which the ratio R is greater than or equal to 0.01 and less than or equal to 1. A first range of preferential damping ratio in which the ratio R is greater than or equal to 0.4 and less than or equal to 1. Finally, a second range of preferential damping ratio in which the ratio R is greater than or equal to 0.6 and less than or equal to 0.9.

### Universal Joint

In the context of the present invention, the concrete embodiment of a universal joint connection 10 is made more complicated by the restricted space and the mass constraints imposed by a multirotor drone. Added to this is the need to transmit the traction force provided by the powertrain 4 to the structure. However, conventional solutions such as blade coupling, Cardan joints or Rzeppa joint do not take up, or take up only inadequately, the traction.

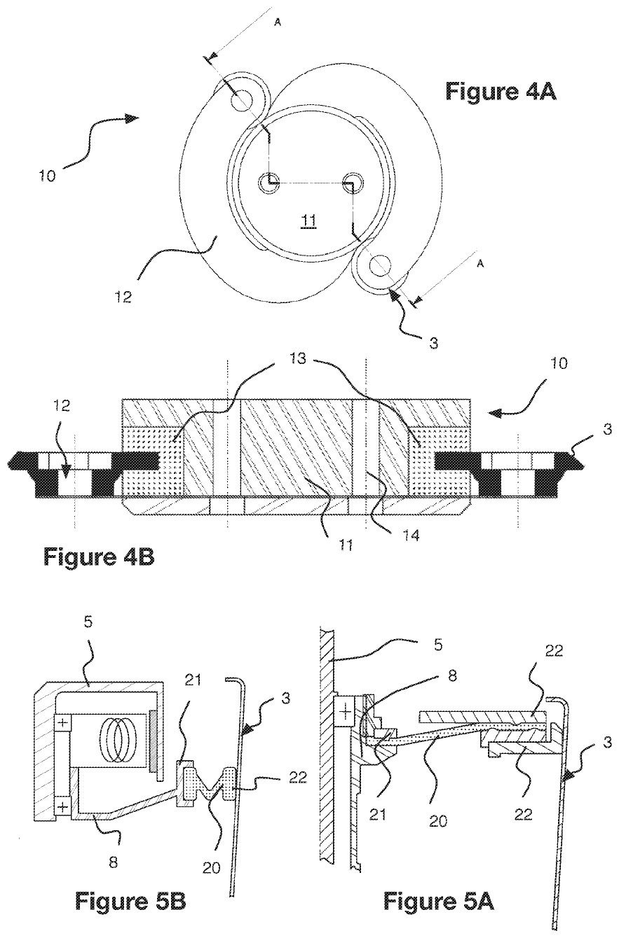

The preferential solution, illustrated in FIGS. 4A and 4B, the powertrain comprises a protruding portion 11 which fits into a homothetic hole of the joint, and is of larger dimensions, by means of a flexible multiaxial connection 13 implemented for example by an elastomeric part that cooperates with the structure of the drone around the hole. Furthermore, a spiral membrane 12 is fastened at its center on the powertrain 4, for example with the aid of the fastening elements 14, and at its ends on the structure of the drone 1. It transmits rigidly the torque of the powertrain 4 to the structure of the drone while the multiaxial flexible connection 13 transmits almost rigidly the traction of the powertrain 4, while leaving it “swivel” around the joint, thanks to local deformations of the elastomer part.

### Soft Link Elements

FIGS. 5A and 5B show two examples of embodiments of a flexible connecting member 20. FIG. 5A shows an exemplary interface between the upper zone of a hollow-axis powertrain with a brushless motor with a rotating cage with the housing structure 3. The figure illustrates the rotor 5 and the stator 8, the latter serving as an attachment point for an inner attachment 21 of a flexible membrane 20, cooperating on the other hand with the housing structure 3 by means of an external fastener 22. FIG. 5B shows an example similar to that of FIG. 5A, for a full-axis powertrain. The figure illustrates the rotor 5 and the stator 8, the latter serving as an attachment point for an inner attachment 21 of a flexible membrane 20, cooperating on the other hand with the housing structure 3 by means of an external fastener 22.

The main difficulty in choosing the flexible connecting members 20 is that a rotor 6 must accelerate to reach a nominal speed. During this acceleration phase, the natural frequency of the device will be reached and exceeded. While passing this natural frequency, it is necessary to have a damping coefficient sufficient to avoid a phenomenon of divergent and potentially destructive resonance. However, this damping must not be too high to avoid canceling the insulating effect of the connection beyond this natural frequency.

In the examples presented here, the flexible connecting members 20 are preferably made using elastomeric materials (rubbers, silicones, latex, etc.).

The figures and their descriptions made above illustrate the invention rather than limiting it. In particular, the invention and its various variants have just been described in connection with a particular example comprising a drone provided with four arms 2 and four rotors 6.

Nevertheless, it is obvious to one skilled in the art that the invention can be extended to other embodiments in which, in variants, a different number of arms and rotors is provided, preferably between four and eight.

1. A drone, comprising a fuselage and a plurality of housing structures in which are arranged a plurality of powertrains, a mechanical connection between each powertrain and each housing structure of a powertrain, wherein said mechanical connection between each powertrain and each housing structure of a powertrain comprises a flexible connecting member connecting the powertrain to the housing structure of the powertrain, wherein said mechanical connection between each powertrain and each housing structure of a powertrain further comprises a universal joint arranged in the axis of rotation of the powertrain, opposite the rotor.

2. The drone according to claim 1, wherein the flexible connecting member is at a distance (I) from the universal joint.

3. The drone according to claim 1, wherein the universal joint is anti-torque.

4. The drone according to claim 1, wherein the flexible connecting member is an elastomeric membrane attached to the upper portion of the powertrain and to the housing structure.

5. The drone according to claim 1, wherein the universal joint comprises a spiral membrane cooperating with the housing structure and with the powertrain and a flexible multiaxial connection in which a prominent portion of the powertrain is inserted.

6. The drone according to claim 1, comprising a damping ratio R=I/L between 0.01 and 1, where L corresponds to the distance between the universal joint and the plane of the rotor, and I corresponds to the distance between said joint and the point of attachment of the flexible connection with the powertrain.

7. The drone according to claim 6, wherein the damping ratio is between 0.4 and 1.

8. The drone according to claim 7, wherein the damping ratio is between 0.6 and 0.9.
